(19) United States
(12) Patent Application Publication
(10) Pub. No.: US 2026/0030360 A1
(43) Pub. Date: Jan. 29, 2026

(54) SYSTEM AND METHOD FOR COMPUTING DEVICE INTRUSION DETECTION VIA MACHINE LEARNING FOR INTERACTION DATA ANALYSIS

(71) Applicant: BANK OF AMERICA CORPORATION, Charlotte, NC (US)

(72) Inventors: James Siekman, Charlotte, NC (US); Ayush Anand, Singapore (SG); Haley Hochberg, Denton, TX (US); Hunter Pace, Charlotte, NC (US); Michael Young, Davidson, NC (US)

(73) Assignee: BANK OF AMERICA CORPORATION, Charlotte, NC (US)

(21) Appl. No.: 18/780,888

(22) Filed: Jul. 23, 2024

(51) Int. Cl. G06F 21/57; G06N 20/00

(52) U.S. Cl. CPC G06F 21/577; G06N 20/00

(57) ABSTRACT

Systems, computer program products, and methods are described herein for computing device intrusion detection via machine learning for interaction data analysis. The present disclosure includes receiving interaction event data, associating the interaction event data with the first endpoint device as a first schema, receiving an interaction event data stream and a corresponding endpoint device identifier, determining, by inputting the interaction event data stream and the corresponding endpoint device identifier to a trained machine learning model, an identified endpoint device and a presence of at least one anomaly, and transmitting a notification signal comprising schema mismatch details to the identified endpoint device.

### TECHNOLOGICAL FIELD

Example implementations of the present disclosure relate to a system and method for computing device intrusion detection via machine learning for interaction data analysis.

### BACKGROUND

In the context of computing devices, users may be exposed to various types of threats that may compromise the device, such as malware, social engineering, credential harvesting, and/or the like. Furthermore, the device itself may be physically compromised by an unauthorized user gaining access and control of the device. Accordingly, there is a need for an effective way to intelligently recognize instances of device compromise.

### BRIEF SUMMARY

Systems, methods, and computer program products are provided for computing device intrusion detection via machine learning for interaction data analysis.

In one aspect, the present disclosure embraces a system for computing device intrusion detection via machine learning for interaction data analysis. The system may include a processing device, and a non-transitory storage device containing instructions, where, when executed by the processing device, the instructions cause the processing device to perform the steps of receiving interaction event data from a first endpoint device, the interaction event data including data from a plurality of keystrokes and a plurality of touch events, associating the interaction event data with the first endpoint device as a first schema within a database, wherein the first endpoint device is designated as an authorized endpoint device, and wherein the database may include a plurality of schema, each respective schema of the plurality of schema including at least one corresponding authorized endpoint device, training a machine learning model using the plurality of schema and the at least one corresponding authorized endpoint device to form a trained machine learning model, receiving an interaction event data stream and a corresponding endpoint device identifier, determining, by inputting the interaction event data stream and the corresponding endpoint device identifier to the trained machine learning model, an identified endpoint device and a presence of at least one anomaly, wherein the at least one anomaly may include a schema mismatch, and transmitting a notification signal including schema mismatch details to the identified endpoint device.

In some implementations, the instructions may further cause the processing device to perform the steps of receiving browser history data from the first endpoint device, associating the browser history data with the first endpoint device in the first schema, receiving a browser data stream, and determining, by inputting the browser data stream and the corresponding endpoint device identifier to the trained machine learning model, the identified endpoint device and the presence of the at least one anomaly.

In some implementations, the instructions may further cause the processing device to perform the steps of scoring, using the trained machine learning model each anomaly of the at least one anomaly, and determining an intrusion event by comparing scores of each anomaly of the at least one anomaly to a predetermined threshold.

In some implementations, the instructions may further cause the processing device to perform the steps of preprocessing the interaction event data and the browser history data to reduce dimensionality of the interaction event data and the browser history data.

In some implementations, the trained machine learning model determines a predicted endpoint device by receiving the interaction event data stream, and wherein the predicted endpoint device is compared to the identified endpoint device for determining the schema mismatch.

In some implementations, the schema mismatch may include an identification of a different schema not associated with the identified endpoint device.

In some implementations, the interaction event data may further include accelerometer data corresponding to at least one selected from the group consisting of the plurality of keystrokes and the plurality of touch events.

In another aspect, the present disclosure embraces computer program product for computing device intrusion detection via machine learning for interaction data analysis. The computer program product including a non-transitory computer-readable medium including code causing an apparatus to receive interaction event data from a first endpoint device, the interaction event data including data from a plurality of keystrokes and a plurality of touch events, associate the interaction event data with the first endpoint device as a first schema within a database, wherein the first endpoint device is designated as an authorized endpoint device, and wherein the database may include a plurality of schema, each respective schema of the plurality of schema including at least one corresponding authorized endpoint device, train a machine learning model using the plurality of schema and the at least one corresponding authorized endpoint device to form a trained machine learning model, receive an interaction event data stream and a corresponding endpoint device identifier, determine, by inputting the interaction event data stream and the corresponding endpoint device identifier to the trained machine learning model, an identified endpoint device and a presence of at least one anomaly, wherein the at least one anomaly may include a schema mismatch, and transmit a notification signal including schema mismatch details to the identified endpoint device.

In some implementations, the code may further cause the apparatus to receive browser history data from the first endpoint device, associate the browser history data with the first endpoint device in the first schema, receive a browser data stream, and determine, by inputting the browser data stream and the corresponding endpoint device identifier to the trained machine learning model, the identified endpoint device and the presence of the at least one anomaly.

In some implementations, the code may further cause the apparatus to score, using the trained machine learning model each anomaly of the at least one anomaly, and determine an intrusion event by comparing scores of each anomaly of the at least one anomaly to a predetermined threshold.

In some implementations, the code may further cause the apparatus to preprocess the interaction event data and the browser history data to reduce dimensionality of the interaction event data and the browser history data.

In some implementations, the trained machine learning model determines a predicted endpoint device by receiving the interaction event data stream, and wherein the predicted endpoint device is compared to the identified endpoint device for determining the schema mismatch.

In some implementations, the schema mismatch may include an identification of a different schema not associated with the identified endpoint device.

In some implementations, the interaction event data may further include accelerometer data corresponding to at least one selected from the group consisting of the plurality of keystrokes and the plurality of touch events.

In yet another aspect, the present disclosure embraces a method for computing device intrusion detection via machine learning for interaction data analysis. The method may include receiving interaction event data from a first endpoint device, the interaction event data including data from a plurality of keystrokes and a plurality of touch events, associating the interaction event data with the first endpoint device as a first schema within a database, wherein the first endpoint device is designated as an authorized endpoint device, and wherein the database may include a plurality of schema, each respective schema of the plurality of schema including at least one corresponding authorized endpoint device, training a machine learning model using the plurality of schema and the at least one corresponding authorized endpoint device to form a trained machine learning model, receiving an interaction event data stream and a corresponding endpoint device identifier, determining, by inputting the interaction event data stream and the corresponding endpoint device identifier to the trained machine learning model, an identified endpoint device and a presence of at least one anomaly, wherein the at least one anomaly may include a schema mismatch, and transmitting a notification signal including schema mismatch details to the identified endpoint device.

In some implementations, the method may further include receiving browser history data from the first endpoint device, associating the browser history data with the first endpoint device in the first schema, receiving a browser data stream, and determining, by inputting the browser data stream and the corresponding endpoint device identifier to the trained machine learning model, the identified endpoint device and the presence of the at least one anomaly.

In some implementations, the method may further include scoring, using the trained machine learning model each anomaly of the at least one anomaly, and determining an intrusion event by comparing scores of each anomaly of the at least one anomaly to a predetermined threshold.

In some implementations, the method may further include preprocessing the interaction event data and the browser history data to reduce dimensionality of the interaction event data and the browser history data.

In some implementations, the trained machine learning model determines a predicted endpoint device by receiving the interaction event data stream, and wherein the predicted endpoint device is compared to the identified endpoint device for determining the schema mismatch.

In some implementations, the schema mismatch may include an identification of a different schema not associated with the identified endpoint device.

The above summary is provided merely for purposes of summarizing some example implementations to provide a basic understanding of some aspects of the present disclosure. Accordingly, it will be appreciated that the above-described implementations are merely examples and should not be construed to narrow the scope or spirit of the disclosure in any way. It will be appreciated that the scope of the present disclosure encompasses many potential implementations in addition to those here summarized, some of which will be further described below.

### BRIEF DESCRIPTION OF THE DRAWINGS

Having thus described implementations of the disclosure in general terms, reference will now be made the accompanying drawings. The components illustrated in the Figures may or may not be present in certain implementations described herein. Some implementations may include fewer (or more) components than those shown in the Figures.

FIGS. 1A-1C illustrate technical components of an exemplary distributed computing environment for computing device intrusion detection via machine learning for interaction data analysis, in accordance with an implementation of the disclosure;

FIG. 2 illustrates an exemplary machine learning model subsystem architecture, in accordance with an implementation of the disclosure; and

FIGS. 3A-3B illustrate a process flow for computing device intrusion detection via machine learning for interaction data analysis, in accordance with an implementation of the disclosure.

### DETAILED DESCRIPTION

Implementations of the present disclosure will now be described more fully hereinafter with reference to the accompanying drawings, in which some, but not all, implementations of the disclosure are shown. Indeed, the disclosure may be implemented in many different forms and should not be construed as limited to the implementations set forth herein; rather, these implementations are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some implementations, the user may be an individual having past relationships, current relationships or potential future relationships with an entity. In some implementations, the user may be an employee (e.g., an associate, a project manager, an IT specialist, a manager, an administrator, an internal operations analyst, or the like) of the entity or enterprises affiliated with the entity.

As used herein, a “user interface” or “display” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, user characteristic information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some implementations, the system may be owned or operated by an entity. In such implementations, the entity may employ additional computer systems, such as authentication servers, to validate and certify resources inputted by the plurality of users within the system. The system may further use its authentication servers to certify the identity of users of the system, such that other users may verify the identity of the certified users. In some implementations, the entity may certify the identity of the users. Furthermore, authentication information or permission may be assigned to or required from a user, application, computing node, computing cluster, or the like to access stored data within at least a portion of the system.

As used herein, an “engine” may refer to core elements of a computer program, or part of a computer program that serves as a foundation for a larger piece of software and drives the functionality of the software. An engine may be self-contained, but externally controllable code that encapsulates powerful logic designed to perform or execute a specific type of function. In one aspect, an engine may be underlying source code that establishes file hierarchy, input and output methods, and how a specific part of a computer program interacts or communicates with other software and/or hardware. The specific components of an engine may vary based on the needs of the specific computer program as part of the larger piece of software. In some implementations, an engine may be configured to retrieve resources created in other computer programs, which may then be ported into the engine for use during specific operational aspects of the engine. An engine may be configurable to be implemented within any general-purpose computing system. In doing so, the engine may be configured to execute source code embedded therein to control specific features of the general-purpose computing system to execute specific computing operations, thereby transforming the general-purpose system into a specific purpose computing system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” or “interaction event” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like. “Interaction event data” may refer to the information generated from user engagements with an entity's services, including but not limited to transaction records, communication logs, user behavior analytics, feedback, and service usage patterns. Interaction event data may be generated in real-time and provided as a stream of interaction data (i.e., an “interaction event data stream”, for example, while a user operates an endpoint device, where the endpoint device collects various sensor feedback including touch or keystrokes rate, touch duration during keystrokes, accelerometer data during keystrokes or handling of the endpoint device, accelerometer data during transportation of the endpoint device, or the like.

As used herein, a “schema” may refer to a structured database that contains user information, login credentials, and endpoint device identifiers. The schema may include tables and relationships that store various data points, such as user information, encrypted passwords, device IDs, and metadata associated with these devices. Additionally, the schema captures comprehensive interaction event data detailing user actions, timestamps, device responses, and other relevant metrics that provide insights into the user's engagement with the endpoint devices.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that an element matches a predetermined criterion, including that a threshold has been met, passed, exceeded, and so on.

It should be understood that the word “exemplary” is used herein to mean “serving as an example, instance, or illustration.” Any implementation described herein as “exemplary” is not necessarily to be construed as advantageous over other implementations.

The technical problem solved herein stems from mobile devices being increasingly susceptible to a range of threats that can compromise their integrity and security. These threats include malware that can be installed through malicious apps or software vulnerabilities, attacks that deceive users into revealing sensitive information, and physical access by unauthorized individuals who can gain control over the device. The challenge lies in developing an intelligent system that can accurately detect these compromises in real time. This system must differentiate between legitimate and malicious activities, even as threats evolve in complexity and sophistication. Effective recognition must also consider scenarios where the device is accessed without the owner's consent, necessitating advanced detection mechanisms to identify unauthorized physical interactions.

Existing solutions for detecting device compromise primarily involve antivirus software and user authentication mechanisms. Antivirus software scans for known malware signatures, but it often fails to detect new or sophisticated malware variants. User authentication methods, such as PINs, passwords, and biometric systems, aim to prevent unauthorized access, but they can be bypassed through social engineering or physical coercion. Additionally, these solutions typically operate in isolation and lack the integrated approach necessary to comprehensively address the multi-faceted nature of modern threats. As a result, there is an urgent need for a more holistic, adaptive solution that can provide robust protection against both digital and physical device compromises.

Addressing these challenges requires the establishment of a system and method for computing device intrusion detection via machine learning for interaction data analysis. Such a framework allows for the detection of unauthorized use of an endpoint device, even if various other security features and authentication credentials are compromised. Indeed, the usage characteristics of a particular endpoint device may be compared to those usage characteristics of authorized users. In this way, the framework may be agnostic to authentication credentials and allow for the determination of unauthorized use.

To do so, interaction event data may be received from an endpoint device, which may include data associated with keystrokes and touch events. This interaction event data may then be associated with the device in a schema that is stored in a database. The database may include multiple schemas for various users and corresponding authorized endpoint devices. The endpoint device may be designated as an authorized endpoint device within the schema. A machine learning model may then be trained, using the schemas in the database, to determine if interaction event data and the identifier of a given endpoint device aligns with the authorized endpoint device(s) for the user. As such, in some implementations, an interaction data stream may be received, and the identity of the user predicted using the machine learning model, based on the interaction event data, and the authorized endpoint device(s) for that predicted user identity is compared to the endpoint device identifier received during the interaction event. Alternatively, or additionally, the endpoint device identifier may allow for the inquiry into users associated with the endpoint device and comparison, using the machine learning model, of the interaction event data to the users associated with the endpoint device. In some implementations, browser history data may be received from the endpoint device and similarly associated with the schema for a user. Upon receiving a browser data stream (i.e., internet traffic), the machine learning model may also utilize this browser stream data to determine any further discrepancies in the schema for schema mismatches. Anomalies between the identified endpoint device and interaction event data may be scored using the machine learning model, and based on that score, the system may determine that there is an intrusion event occurring or that an intrusion event has occurred in the recent past, by comparing the score to a predetermined threshold. Mismatches in schema predictions, or determining of an intrusion event, may result in the transmitting of notification signal(s), authentication credential prompts, and/or disabling of an endpoint device.

What is more, the present disclosure provides a technical solution to a technical problem. As described herein, the technical problem includes a lack of an ability to recognize malicious attacks or malfeasant conduct when an endpoint device is accessed without the owner's consent, either physically or through malware, when traditional authentication protocols are successfully circumvented, or authentication credentials are otherwise provided in a malfeasant manner. The present disclosure embraces an improvement over existing solutions by allowing for the notification and identification of such nefarious activity (i) with fewer steps to achieve the solution (e.g., providing a means to verify a user's identity without multi-factor authentication), thus reducing the amount of network resources, such as processing resources, storage resources, network resources, and/or the like, that are being used, (ii) providing a more accurate solution to problem, thus reducing the number of resources required to remedy any errors made due to a less accurate solution (e.g., identifying the user in possession of an endpoint device without using network resources to implement recurring authentication credential requests), (iii) removing manual input and waste from the implementation of the solution, thus improving speed and efficiency of the process and conserving network resources (e.g., preventing the necessity for humans to proactively audit activity on an endpoint device and notify the true owner thereof of any nefarious activity), (iv) determining an optimal amount of resources that need to be used to implement the solution, thus reducing network traffic and load on existing network resources (e.g., minimizing redundant authentication attempts and queries and intelligently managing communication flows). In other words, the solution may bypass a series of steps previously implemented, thus further conserving network resources. Furthermore, the technical solution described herein uses a rigorous, computerized process to perform specific tasks and/or activities that were not previously performed.

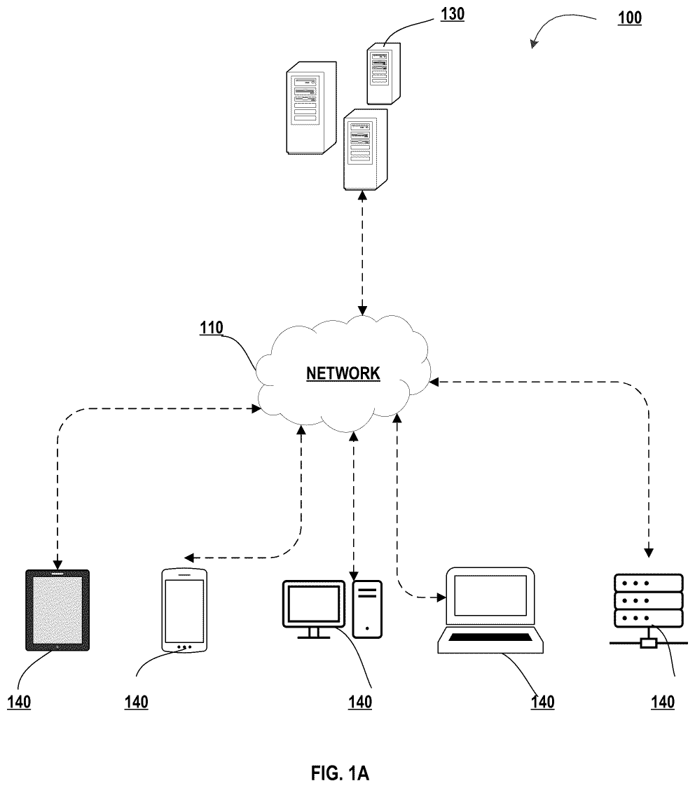

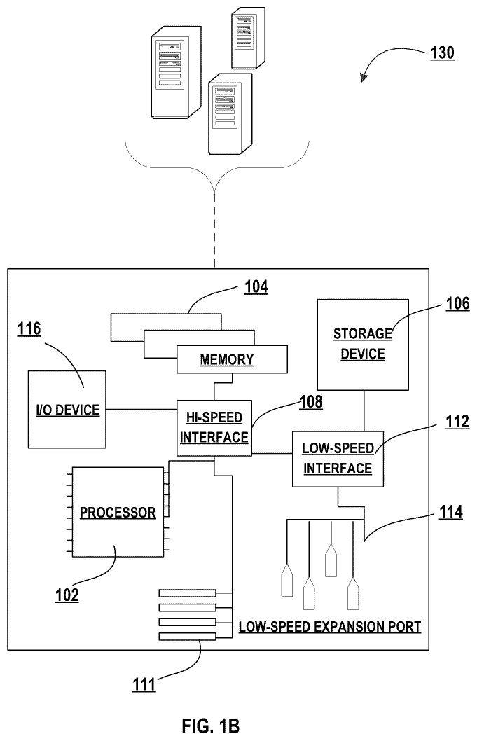

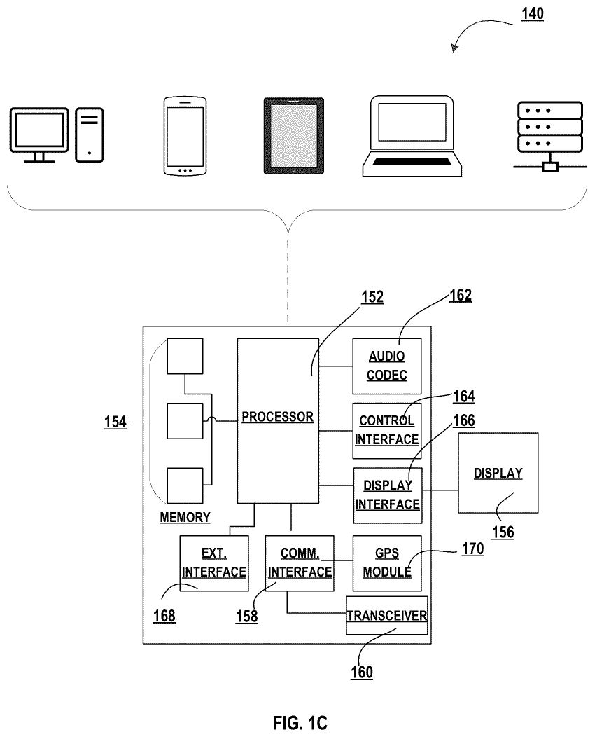

FIGS. 1A-1C illustrate technical components of an exemplary distributed computing environment 100 for computing device intrusion detection via machine learning for interaction data analysis, in accordance with an implementation of the disclosure. As shown in FIG. 1A, the distributed computing environment 100 contemplated herein may include a system 130, an endpoint device(s) 140, and a network 110 over which the system 130 and endpoint device(s) 140 communicate therebetween. FIG. 1A illustrates only one example of an implementation of the distributed computing environment 100, and it will be appreciated that in other implementations one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some implementations, the system 130 and the endpoint device(s) 140 may have a client-server relationship in which the endpoint device(s) 140 are remote devices that request and receive service from a centralized server, i.e., the system 130. In some other implementations, the system 130 and the endpoint device(s) 140 may have a peer-to-peer relationship in which the system 130 and the endpoint device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The endpoint device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. In addition to shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an implementation of the disclosure. As shown in FIG. 1B, the system 130 may include a processing device 102, memory 104, input/output (I/O) device 116, and a storage device 106. The system 130 may also include a high-speed interface 108 connecting to the memory 104, and a low-speed interface 112 connecting to a low-speed bus 114 and a storage device 106. Each of the components 102, 104, 108, 110, and 112 may be operatively coupled to one another using various buses and may be mounted on a common motherboard or in other manners as appropriate. As described herein, the processing device 102 may include a number of subsystems to execute the portions of processes described herein. Each subsystem may be a self-contained component of a larger system (e.g., system 130) and capable of being configured to execute specialized processes as part of the larger system.

The processing device 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processing devices, along with multiple memories, and/or I/O devices, to execute the processes described herein. In other words, as used herein, a “processing device” means one processing device (e.g., a microprocessor) that performs the defined functions or a plurality of processing devices (e.g., microprocessors) that collectively perform defined functions such that the execution of the individual defined functions may be divided amongst such processing devices.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly implemented in an information carrier. The computer program product may also contain instructions that, when executed, perform one or more methods, such as those described above. The information carrier may be a non-transitory computer-or machine-readable storage medium, such as the memory 104, the storage device 106, or memory on processing device 102.

The high-speed interface 108 manages bandwidth-intensive operations for the system 130, while the low-speed controller 112 manages lower bandwidth-intensive operations. Such allocation of functions is exemplary only. In some implementations, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the endpoint device(s) 140, in accordance with an implementation of the disclosure. As shown in FIG. 1C, the endpoint device(s) 140 includes a processing device 152, memory 154, an input/output device such as a display 156, a communication interface 158, and a transceiver 160, among other components. The endpoint device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processing device 152 is configured to execute instructions within the endpoint device(s) 140, including instructions stored in the memory 154, which in one implementation includes the instructions of an application that may perform the functions disclosed herein, including certain logic, data processing, and data storing functions. The processing device may be implemented as a chipset of chips that include separate and multiple analog and digital processors. The processing device may be configured to provide, for example, for coordination of the other components of the endpoint device(s) 140, such as control of user interfaces, applications run by endpoint device(s) 140, and wireless communication by endpoint device(s) 140.

The processing device 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processing device 152. In addition, an external interface 168 may be provided in communication with processing device 152, so as to enable near area communication of endpoint device(s) 140 with other devices. External interface 168 may provide, for example, for wired communication in some implementations, or for wireless communication in other implementations, and multiple interfaces may also be used.

The memory 154 stores information within the endpoint device(s) 140. The memory 154 can be implemented as one or more of a computer-readable medium or media, a volatile memory unit or units, or a non-volatile memory unit or units. Expansion memory may also be provided and connected to endpoint device(s) 140 through an expansion interface (not shown), which may include, for example, a SIMM (Single In Line Memory Module) card interface. Such expansion memory may provide extra storage space for endpoint device(s) 140 or may also store applications or other information therein. In some implementations, expansion memory may include instructions to carry out or supplement the processes described above and may include secure information also. For example, expansion memory may be provided as a security module for endpoint device(s) 140 and may be programmed with instructions that permit secure use of endpoint device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly implemented in an information carrier. The computer program product contains instructions that, when executed, perform one or more methods, such as those described herein. The information carrier is a computer-or machine-readable medium, such as the memory 154, expansion memory, memory on processing device 152, or a propagated signal that may be received, for example, over transceiver 160 or external interface 168.

In some implementations, the user may use the endpoint device(s) 140 to transmit and/or receive information or commands to and from the system 130 via the network 110. Any communication between the system 130 and the endpoint device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the endpoint device(s) 140 may provide the system 130 (or other client devices) permissioned access to the protected resources of the endpoint device(s) 140, which may include a GPS device, an image capturing component (e.g., camera), a microphone, and/or a speaker.

The endpoint device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to endpoint device(s) 140, which may be used as appropriate by applications running thereon, and in some implementations, one or more applications operating on the system 130.

The endpoint device(s) 140 may also communicate audibly using audio codec 162, which may receive spoken information from a user and convert the spoken information to usable digital information. Audio codec 162 may likewise generate audible sound for a user, such as through a speaker, e.g., in a handset of endpoint device(s) 140. Such sound may include sound from voice telephone calls, may include recorded sound (e.g., voice messages, music files, etc.) and may also include sound generated by one or more applications operating on the endpoint device(s) 140, and in some implementations, one or more applications operating on the system 130.

Various implementations of the distributed computing environment 100, including the system 130 and endpoint device(s) 140, and techniques described here can be realized in digital electronic circuitry, integrated circuitry, specially designed ASICs (application specific integrated circuits), computer hardware, firmware, software, and/or combinations thereof.

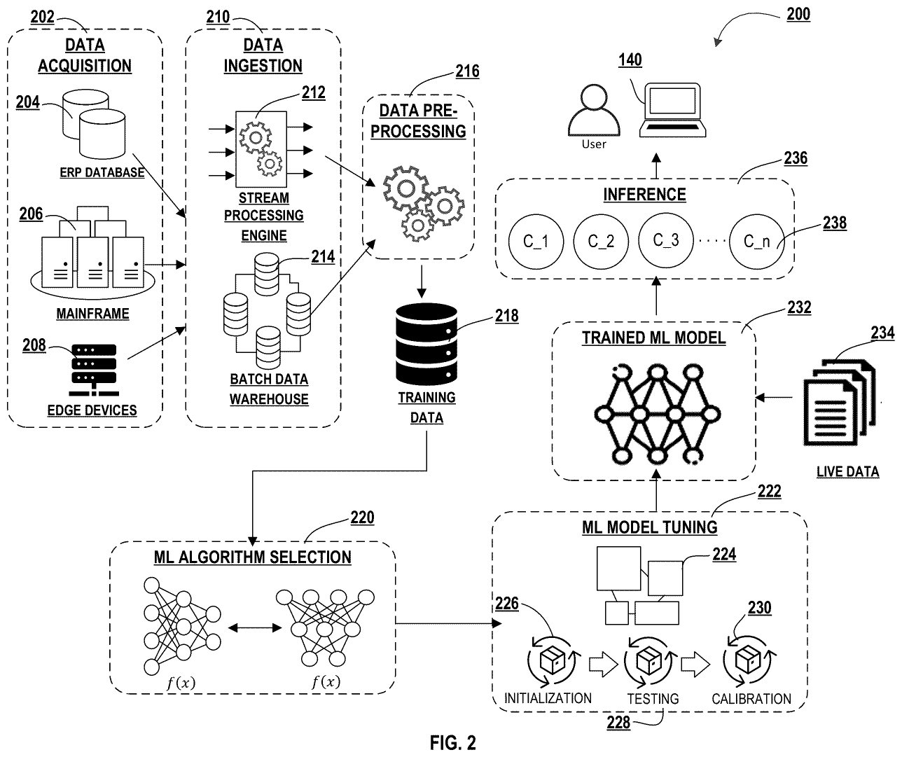

FIG. 2 illustrates an exemplary machine learning model subsystem architecture 200, in accordance with an implementation of the disclosure. The machine learning subsystem 200 may include a data acquisition engine 202, data ingestion engine 210, data pre-processing engine 316, machine learning model tuning engine 222, and inference engine 236.

The data acquisition engine 202 may identify various internal and/or external data sources to generate, test, and/or integrate new features for training the machine learning model. These internal and/or external data sources 204, 206, and 208 may be initial locations where the data originates or where physical information is first digitized. The data acquisition engine 202 may identify the location of the data and describe connection characteristics for access and retrieval of data. In some implementations, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some implementations, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of network resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points. As will be understood in view of the present disclosure, training data 218 may additionally, or alternatively, be provided from a third party, having been generated as synthetic data.

The machine learning model tuning engine 222 may be used to train a machine learning model to form a trained machine learning model 232 using the training data 218 to make predictions or decisions without explicitly being programmed to do so. The machine learning model 232 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms can adjust their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the machine learning model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the machine learning model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2. . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2. . . . C_n 238) live data 234 based on how similar they are to one another to solve exploratory challenges where little is known about the data, provide a description or label (e.g., C_1, C_2. . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It shall be understood that the implementation of the machine learning subsystem 200 illustrated in FIG. 2 is exemplary and that other implementations may vary. As another example, in some implementations, the machine learning subsystem 200 may include more, fewer, or different components.

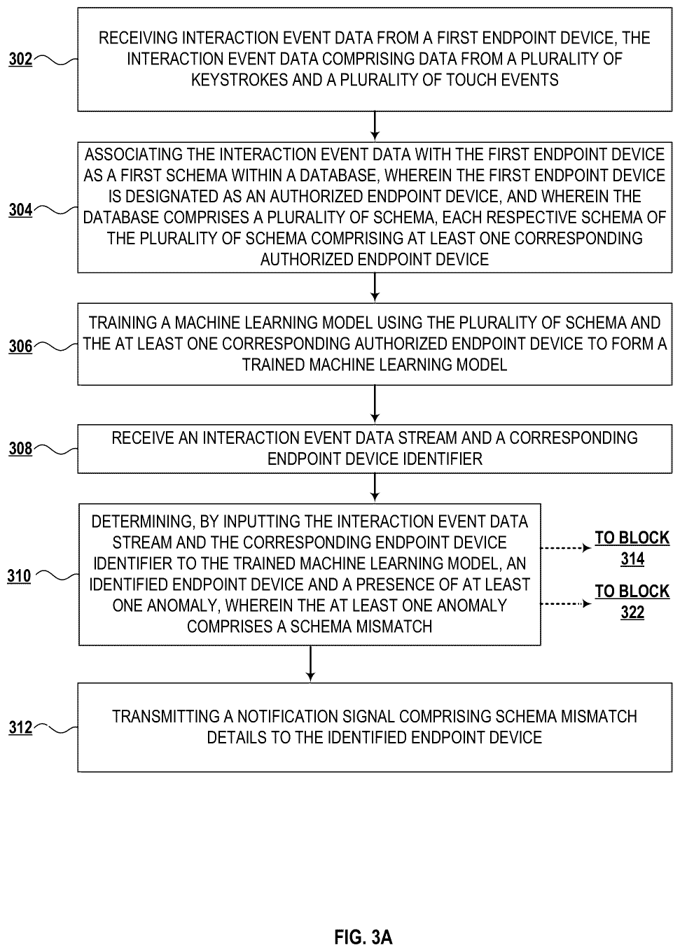

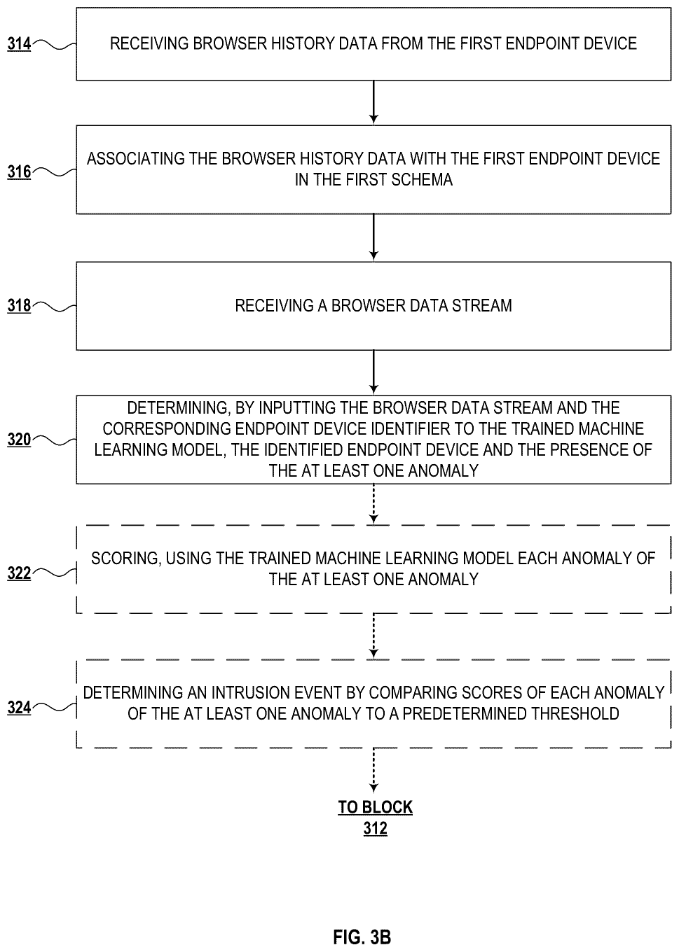

FIGS. 3A-3B illustrate a process flow for computing device intrusion detection via machine learning for interaction data analysis, in accordance with an implementation of the disclosure. At block 302 the system 130 may receive interaction event data from a first endpoint device 140. As described and defined in detail herein, this interaction event data may include keystrokes and the data associated with the keystrokes, such as the rate of typing on a keyboard or virtual touchscreen keyboard, subtle typing patterns such as the number of spaces between sentences or sentence structure, or the like. Keystrokes may also include the specific words used frequently by a user. Any or all of the foregoing data may be collected from a plurality of keystrokes.

Additionally, or alternatively, the interaction event data may include a plurality of touch events. Touch events may be the rate at which a user interacts with various applications on the endpoint device 140, for example how quickly the user changes from one application to another application.

In addition to, or as an alternative to the foregoing, the system 130 may also collect accelerometer data from the endpoint device 140 during keystrokes, during touch events, while the endpoint device 140 is displaying data on the interface, and/or while the endpoint device 140 is resting (i.e., no data displayed on the interface). The accelerometer in the endpoint device 140 may measure acceleration in up to three orthogonal axes (X, Y, and/or Z). To do so, the accelerometer may detect changes in velocity by measuring a response to inertial forces. The data may be output in meters per second squared (m/s²). Sampling rates can range from 1 Hz to several kHz, with resolutions from 8-bit to 16-bit. The accelerometer may detect static acceleration (gravity) and dynamic acceleration (movement), allowing for calculations of velocity, displacement, and orientation changes.

Accordingly, the system 130 may be able to receive such data, and as will be described in detail herein, compare the expected acceleration on the endpoint device 140 (e.g., acceleration during keystrokes, touch events, transport of the endpoint device 140, or other interactions with the endpoint device 140) as well as expected orientations of the endpoint device 140 (e.g., the orientation and operating angle(s) of the endpoint device 140 during keystrokes, touch events, transport of the endpoint device 140, or other interactions with the endpoint device 140).

Additionally, or alternatively, the endpoint device 140 of the system 130 may collect forces on the touchscreen interface (e.g., acceleration during keystrokes, touch events, transport of the endpoint device 140, or other interactions with the endpoint device 140) by implementing one or more pressure sensors on the touchscreen interface. For example, capacitive pressure sensors in the touchscreen interface may measure changes in capacitance when a force is applied to the screen. Indeed, the amount of force used (e.g., pounds per square inch, or the like) by the user to input text using the touchscreen keyboard may be collected, and/or the amount of force used by the user during touch events involving interacting with elements on the screen of the endpoint device 140, such as when zooming on a photograph, scrolling, or the like.

Additionally, or alternatively, the endpoint device 140 may collect the frequency of interactions between the user and the endpoint device 140 over a given timespan. For example, a first user may interact with the endpoint device 140 five (5) times over the course of one (1) hour. Interaction data volume may be calculated as a function of number of interactions per minute, per hour, per day, per week, and so forth. This volume calculation may further be multiplied by a factor such as length of the interactions, longest length of any given interaction, average length of interaction, or the like.

At block 304, the system 130 may associate the interaction event data received at block 302 with the first endpoint device 140 (i.e., the endpoint device 140 that provided the interaction event data) as a first schema within a database. The first endpoint device 140 may be identified through one or more endpoint device identifiers, including, but not limited to, unique device identifier (UDID) or universally unique identifier (UUID), International Mobile Equipment Identity (IMEI), Mobile Equipment Identifier (MEID), Media Access Control (MAC) address, Internet Protocol (IP) addresses, serial numbers and hardware identifiers (HWIDs), software identifiers, like device names or user-assigned labels.

Within the database, the first endpoint device 140 (via the endpoint device identifier(s)) may be designated as an authorized endpoint device 140. In other words, the endpoint device 140 will be associated with the user. It shall be appreciated that there may be multiple authorized endpoint devices 140 associated with one user. Similarly, it shall be appreciated that there may be multiple users as authorized users for a single endpoint device 140, or, stated differently, an endpoint device 140 may be an “authorized device” for more than one user.

Users may be referred to (i.e., user references) in one or more ways in the database. For example, unique user identifiers or user IDs, email addresses, usernames, authentication credentials, such as passwords, fingerprints, facial recognition, phone numbers, social security numbers, account numbers, customer IDs, membership numbers, IP addresses, session IDs, names, addresses, birth dates, or the like.

Each user may be represented within the database as a schema, which may contain not only the foregoing user reference(s), but also the one or more authorized endpoint devices 140 associated with the user, and the interaction event data received in block 302. As such, each schema represents a repository of information regarding the usage characteristics of a user (keystrokes, touch events, accelerometer data, force sensor data, or the like) and their associated endpoint devices 140.

Next, at block 306, the process may continue by training a machine learning model using the plurality of schema. In some implementations, the machine learning model may be trained by structuring the dataset such that each schema is represented as a mapping between user reference(s) and endpoint device identifier(s) of authorized endpoint device(s) 140. For example, a data point might include pairs like ([User Reference A], [Authorized Endpoint Device 1, Authorized Endpoint Device 2, Authorized Endpoint Device 14]), ([User Reference A], [Authorized Endpoint Device 43, Authorized Endpoint Device 45, Authorized Endpoint Device 17]), and so forth. The training process may include creating two sets of labeled data: one where user reference(s) are the input and endpoint device identifier(s) are the target, and another where endpoint device identifier(s) are the input and user reference(s) are the target. For the former, each endpoint device identifier(s) set (e.g., [Authorized Endpoint Device 2, Authorized Endpoint Device 14]) is labeled with its corresponding user reference(s) (e.g., User Reference A). For the latter, each of the user reference(s) (e.g., User Reference A) is labeled with its associated endpoint device identifier(s) set (e.g., [Authorized Endpoint Device 2, Authorized Endpoint Device 14]).

Additionally, or alternatively, the machine learning model may be trained using the interaction event data, for example, a keystroke rate, touch event rate, accelerometer data during keystrokes (including orientation, acceleration, or the like), force measurements from the user interface during keystrokes or touch events, accelerometer data during non-use of the endpoint device 140, and so forth, many additional examples of which are disclosed herein. To do so, three labeled datasets may be created, including one dataset that includes endpoint device identifier(s) and interaction event data as inputs, and predicting the corresponding user reference(s), another dataset that includes user reference(s) and interaction event data as inputs, and predicting the corresponding endpoint device identifier(s), and another dataset that includes user reference(s) and endpoint device identifier(s), and predicting the corresponding interaction event data.

In this way, a trained machine learning model 232 is formed, capable of at least predicting a user based on interaction event data, predicting an endpoint device 140 based on interaction event data, predicting an authorized endpoint device 140 based on a user, and predicting a user based on an endpoint device identifier, and various combinations thereof.

To facilitate the training of the machine learning model and provide the machine learning model the training in an efficient manner, the system 130 may preprocess the interaction event data to reduce dimensionality of the interaction event data. In doing so, the number of variables in the interaction event data may be reduced, and instead only a set of principal variables considered for training. For example, interaction event data may contain accelerometer data for during keystrokes (Feature “A”), force sensor data during keystrokes (Feature “B”), keystroke speed (i.e., the amount of time in between two successive keystrokes) (Feature “C”), and keystroke duration (i.e., the amount of time that one's finger stays in contact with a user interface during one keystroke) (Feature “D”). Using Principal Component Analysis, a covariance matrix of Features A, B, C, and D. Eigenvectors and eigenvalues of the covariance matrix may then be computed, where the top eigenvectors (less than the number of Features) are selected based on the largest eigenvalues and deemed the principal components.

The process may continue at block 308, where the system 130 receives an interaction event data stream. The interaction event data stream may include a continuous or semi-continuous incoming data stream received by the system 130, the incoming data stream containing interaction event data collected during the interaction between a user and an endpoint device 140. The interaction event data stream may also include an endpoint device identifier corresponding to the endpoint device 140 with which the user is interacting to create such interaction event data.

In some implementations, the interaction event data stream may be provided to the system 130 in real-time, such that the interaction event data is routed to the system 130 immediately after collection of the interaction event data. In other implementations, the interaction event data stream may be transmitted to the system 130 after storage in a memory device for a predetermined time such as to queue the interaction event data and provide it to the system 130 without overloading the processing capacity thereof.

At block 310, the system 130 may determine an identified endpoint device 140 and a presence of at least one anomaly by inputting the interaction event data stream and the corresponding endpoint device identifier to the trained machine learning model 232.

In implementations where the interaction event data stream is being received in real-time, the interaction event data therein may be provided to the trained machine learning model 232 on a batch processing basis, such as a predetermined amount of data accumulated and then processed by the trained machine learning model 232 at once to provide a prediction (i.e., the identified endpoint device 140 and a presence of at least one anomaly). The predetermined amount of data accumulated may be based on a predetermined size limit, a predetermined number of datapoints for a given type of data, or the like. Alternatively, the interaction event data within the interaction event data stream may be provided to the trained machine learning model 232 on a piece-by-piece basis, and the model may then output a prediction (i.e., the identified endpoint device 140 and a presence of at least one anomaly) incrementally at a predetermined interval.

The at least one anomaly identified by the trained machine learning model 232 may include a schema mismatch, meaning, the interaction data provided to the trained machine learning model 232 led to the identification of a schema associated with an endpoint device 140 different than the identified endpoint device 140 (i.e., the device identified by the trained machine learning model 232 using the endpoint device identifier).

Turning now to FIG. 3B, the process may continue at block 314, where in some implementations, the system 130 receives browser history data from the first endpoint device 140. Along with the aforementioned interaction event data, it shall be appreciated that users in control of an endpoint device 140 typically interact with a finite number of domains through their internet browser. These domains for one user may typically be a common set of generic top-level domains (“gTLD”), country-code top-level domains (“ccTLD”), or the like, and rarely use more obscure domains. For example, a user may browse “.com” “.net” and “.org” domains daily, but never visit a “.ru” or “.cn” domain. Indeed, browser history data that includes a “.ru” or “.cn” domain for this given user may be an indication that nefarious activity has been engaged in on the endpoint device 140, cither through manipulation by a nefarious person in control of the endpoint device 140, or via malware installed on the endpoint device 140.

In some implementations, after the browser history data has been received, the system 130 may preprocess the browser history data to reduce dimensionality of the browser history data. The browser history data may include URLs, timestamps, visited page content, or the like. Dimensionality techniques may be applied such as Principal Component Analysis may be applied to reduce complexity of the data and lead to a more efficient use of the machine learning model 232.

Similar to the interaction event data, in some implementations, the browser history data may be provided to the system 130 in real-time (e.g., via browser data stream), such that the browser history data is routed to the system 130 immediately after collection of the browser history data. In other implementations, the browser history data may be transmitted to the system 130 after storage in a memory device for a predetermined time such as to queue the browser history data and provide it to the system 130 without overloading the processing capacity thereof.

Next, at block 316, the system 130 may associate the browser history data with the first endpoint device 140 in the first schema. Similar to the interaction event data, the first schema may now include the browser history data such that the browsing tendencies of a user will be associated with the schema that includes that user.

Similarly, the machine learning model may be trained using the browser history data. To do so, additional labeled datasets may be created, including using endpoint device identifier(s), interaction event data, and/or user reference(s) as inputs and labeled browser history data as outputs for tuning of the machine learning model 232. In this way, the trained machine learning model 232 understands of a user from which browser history data has been collected.

At block 318, the system 130 may receive the browser data stream. Then, the system 130 may determine the identified endpoint device 140 and the presence of the at least one anomaly by inputting the browser data stream and the corresponding endpoint device identifier to the trained machine learning model 232. The at least one anomaly may be a variation in the browsing history of the endpoint device 140 and/or the browsing history associated with an authorized user of the endpoint device 140.

In some implementations, the process may continue at block 322, where the system 130 scores each anomaly of the at least one anomaly using the trained machine learning model 232. The system 130 may determine scores of one of several different forms. In some implementations, the score may be a numerical value on a predetermined scale, such as from 1 to 10, 1 to 100, and so forth. The trained machine learning model 232 may analyze the foregoing interaction event data, browser history data, and/or endpoint device identifier and generate an output of a score based on the severity of the anomaly.

To do so, distance-based methods may be implemented by the machine learning model 232 to detect anomalies, which evaluate the distances between data points. As one example, in K-Nearest Neighbors (KNN) method, the average distance to the k-nearest neighbors is calculated, with higher distances indicating anomalies. Clustering methods, such as DBSCAN and k-means, may instead identify anomalies by measuring the distance of a point to its cluster centroid, where larger distances signal potential anomalies. The score can be generated by normalizing these distances and assigning higher scores to points (on a predetermined scale) with greater distances from their neighbors or centroids.

Additionally, or alternatively, density-based methods may be implemented, such as Local Outlier Factor (LOF), to assess the local density of a point compared to its neighbors. Points with significantly lower local density may be flagged as anomalies. The LOF algorithm generates a score by comparing the local density of a point to the densities of its neighbors, with higher scores (on a predetermined scale) indicating stronger anomalies. Similarly, an Isolation Forest algorithm may isolate data points and assign higher anomaly scores to points that are isolated quickly, suggesting they are outliers, by determining the number of partitions required to isolate a point, with fewer partitions resulting in higher scores.

In some implementations, the system 130 may repeat the scoring at a predetermined interval during the receiving of the interaction event data stream and/or the browser data stream. Stated differently, the system 130 may repeat one or more of the actions of block 322 in an ongoing manner according to predetermined time intervals, for example, every 5 seconds, 10 seconds, 30 seconds, 1 minute, 2 minutes, 3 minutes, 5 minutes, 10 minutes, 30 minutes, or any other length of time.

Next, at block 324, the system 130 may determine an intrusion event by comparing scores of each anomaly of the at least one anomaly to a predetermined threshold. A predetermined threshold may be set to indicate that anomalies over the predetermined threshold are significant (i.e., inferred to be an intrusion event not authorized by any authorized user), and may require further action or notification. For example, if the KNN clustering method is used for scoring (i.e., finding distances between points), a maximum distance may be set as a predetermined threshold such that distances below the predetermined threshold are ignored or otherwise not determined to be intrusion events.

Returning back now to FIG. 3A, at block 312, the system 130 may transmit a notification signal including schema mismatch details to the identified endpoint device 140. The system 130 may transmit a first notification signal to a first endpoint device 140 associated with the first user. The first notification signal may be sent using a pre-determined communication protocol, and through a wireless network, a wired connection, or an internet-based platform, depending on the infrastructure in place. In some implementations, the first notification signal may trigger a notification alert to capture the first user's attention. To this end, the first notification signal (or the notification alert triggered by the notification signal) may include data for display of a splash banner, and the system 130 may display the splash banner on a first endpoint device 140 associated with the first user. The mismatch details in the notification signal may identify the suspected nefarious activity, such as the browser history data and/or interaction event data that led to the determination that there was an intrusion event. The notification signal may also include instructions for how to defeat the suspected intrusion event and allow for continued use of the first endpoint device 140. For example, an additional layer of authentication credentials may be queried by the first endpoint device 140 such as to ensure that the user of the first endpoint device 140 is an authorized user.

Additionally, or alternatively, the notification signal may lock or freeze the first endpoint device 140 from further use and require override to the locking of the first endpoint device 140 by an employee of the entity.

Additionally, or alternatively, the system 130 may transmit a notification signal to a second endpoint device (i.e., a “second notification signal”). For example, a second endpoint device may be monitored by an employee of the entity, and therefore a notification may be generated to alert the employee of the entity that the first endpoint device intrusion event. The second notification signal may similarly include schema mismatch details. In some implementations, the second notification signal may include contact information for the first user, or a predetermined authorized user of the first endpoint device 140, such as to facilitate the communication to such user that an intrusion event has occurred.

As will be appreciated by one of ordinary skill in the art, the present disclosure may be implemented as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other implementations of the present disclosure set forth herein will come to mind to one skilled in the art to which these implementations pertain having the benefit of the teachings presented in the foregoing descriptions and the associated drawings. Although the Figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A system for computing device intrusion detection via machine learning for interaction data analysis, the system comprising:
a processing device; and
a non-transitory storage device containing instructions, where, when executed by the processing device, the instructions cause the processing device to perform the steps of:
receiving interaction event data from a first endpoint device, the interaction event data comprising data from a plurality of keystrokes and a plurality of touch events;
associating the interaction event data with the first endpoint device as a first schema within a database, wherein the first endpoint device is designated as an authorized endpoint device, and wherein the database comprises a plurality of schema, each respective schema of the plurality of schema comprising at least one corresponding authorized endpoint device;
training a machine learning model using the plurality of schema and the at least one corresponding authorized endpoint device to form a trained machine learning model;
receiving an interaction event data stream and a corresponding endpoint device identifier;
determining, by inputting the interaction event data stream and the corresponding endpoint device identifier to the trained machine learning model, an identified endpoint device and a presence of at least one anomaly, wherein the at least one anomaly comprises a schema mismatch; and
transmitting a notification signal comprising schema mismatch details to the identified endpoint device.

2. The system of claim 1, wherein the instructions further cause the processing device to perform the steps of:
receiving browser history data from the first endpoint device;
associating the browser history data with the first endpoint device in the first schema;
receiving a browser data stream; and
determining, by inputting the browser data stream and the corresponding endpoint device identifier to the trained machine learning model, the identified endpoint device and the presence of the at least one anomaly.

3. The system of claim 1, wherein the instructions further cause the processing device to perform the steps of:
scoring, using the trained machine learning model each anomaly of the at least one anomaly; and
determining an intrusion event by comparing scores of each anomaly of the at least one anomaly to a predetermined threshold.

4. The system of claim 2, wherein the instructions further cause the processing device to perform the steps of:
preprocessing the interaction event data and the browser history data to reduce dimensionality of the interaction event data and the browser history data.

5. The system of claim 1, wherein the trained machine learning model determines a predicted endpoint device by receiving the interaction event data stream, and wherein the predicted endpoint device is compared to the identified endpoint device for determining the schema mismatch.

6. The system of claim 1, wherein the schema mismatch comprises an identification of a different schema not associated with the identified endpoint device.

7. The system of claim 1, wherein the interaction event data further comprises accelerometer data corresponding to at least one selected from the group consisting of the plurality of keystrokes and the plurality of touch events.

8. A computer program product for computing device intrusion detection via machine learning for interaction data analysis, the computer program product comprising a non-transitory computer-readable medium comprising code causing an apparatus to:
receive interaction event data from a first endpoint device, the interaction event data comprising data from a plurality of keystrokes and a plurality of touch events;
associate the interaction event data with the first endpoint device as a first schema within a database, wherein the first endpoint device is designated as an authorized endpoint device, and wherein the database comprises a plurality of schema, each respective schema of the plurality of schema comprising at least one corresponding authorized endpoint device;
train a machine learning model using the plurality of schema and the at least one corresponding authorized endpoint device to form a trained machine learning model;
receive an interaction event data stream and a corresponding endpoint device identifier;
determine, by inputting the interaction event data stream and the corresponding endpoint device identifier to the trained machine learning model, an identified endpoint device and a presence of at least one anomaly, wherein the at least one anomaly comprises a schema mismatch; and
transmit a notification signal comprising schema mismatch details to the identified endpoint device.

9. The computer program product of claim 8, wherein the code further causes the apparatus to:
receive browser history data from the first endpoint device;
associate the browser history data with the first endpoint device in the first schema;
receive a browser data stream; and
determine, by inputting the browser data stream and the corresponding endpoint device identifier to the trained machine learning model, the identified endpoint device and the presence of the at least one anomaly.

10. The computer program product of claim 8, wherein the code further causes the apparatus to:
score, using the trained machine learning model each anomaly of the at least one anomaly; and
determine an intrusion event by comparing scores of each anomaly of the at least one anomaly to a predetermined threshold.

11. The computer program product of claim 9, wherein the code further causes the apparatus to:
preprocess the interaction event data and the browser history data to reduce dimensionality of the interaction event data and the browser history data.

12. The computer program product of claim 8, wherein the trained machine learning model determines a predicted endpoint device by receiving the interaction event data stream, and wherein the predicted endpoint device is compared to the identified endpoint device for determining the schema mismatch.

13. The computer program product of claim 8, wherein the schema mismatch comprises an identification of a different schema not associated with the identified endpoint device.

14. The computer program product of claim 8, wherein the interaction event data further comprises accelerometer data corresponding to at least one selected from the group consisting of the plurality of keystrokes and the plurality of touch events.

15. A method for computing device intrusion detection via machine learning for interaction data analysis, the method comprising:
receiving interaction event data from a first endpoint device, the interaction event data comprising data from a plurality of keystrokes and a plurality of touch events;
associating the interaction event data with the first endpoint device as a first schema within a database, wherein the first endpoint device is designated as an authorized endpoint device, and wherein the database comprises a plurality of schema, each respective schema of the plurality of schema comprising at least one corresponding authorized endpoint device;
training a machine learning model using the plurality of schema and the at least one corresponding authorized endpoint device to form a trained machine learning model;
receiving an interaction event data stream and a corresponding endpoint device identifier;
determining, by inputting the interaction event data stream and the corresponding endpoint device identifier to the trained machine learning model, an identified endpoint device and a presence of at least one anomaly, wherein the at least one anomaly comprises a schema mismatch; and
transmitting a notification signal comprising schema mismatch details to the identified endpoint device.

16. The method of claim 15, wherein the method further comprises:
receiving browser history data from the first endpoint device;
associating the browser history data with the first endpoint device in the first schema;
receiving a browser data stream; and
determining, by inputting the browser data stream and the corresponding endpoint device identifier to the trained machine learning model, the identified endpoint device and the presence of the at least one anomaly.

17. The method of claim 15, wherein the method further comprises:
scoring, using the trained machine learning model each anomaly of the at least one anomaly; and
determining an intrusion event by comparing scores of each anomaly of the at least one anomaly to a predetermined threshold.

18. The method of claim 16, wherein the method further comprises:
preprocessing the interaction event data and the browser history data to reduce dimensionality of the interaction event data and the browser history data.

19. The method of claim 15, wherein the trained machine learning model determines a predicted endpoint device by receiving the interaction event data stream, and wherein the predicted endpoint device is compared to the identified endpoint device for determining the schema mismatch.

20. The method of claim 15, wherein the schema mismatch comprises an identification of a different schema not associated with the identified endpoint device.
